(19) United States
(12) Patent Application Publication
(10) Pub. No.: US 2026/0127701 A1
(43) Pub. Date: May 7, 2026

(54) COOPERATIVE EXECUTION OF SUBGROUP OPERATIONS

(71) Applicant: QUALCOMM Incorporated, San Diego, CA (US)

(72) Inventors: Adimulam RAMESH BABU, San Diego, CA (US); Alfredo Olegario SAUCEDO, San Diego, CA (US); Srihari Babu ALLA, San Diego, CA (US); Avinash SEETHARAMAIAH, San Diego, CA (US); Jonnala Gadda NAGENDRA KUMAR, San Diego, CA (US)

(21) Appl. No.: 18/938,157

(22) Filed: Nov. 5, 2024

(51) Int. Cl. G06T 1/20; G06T 1/60

(52) U.S. Cl. CPC G06T 1/20; G06T 1/60

(57) ABSTRACT

This disclosure provides systems, devices, apparatus, and methods, including computer programs encoded on storage media, for concurrently executing disjoint write operations. A graphics processor may receive a representation of source code. The source code may include a group of operations that write to a shared dataset. The group of operations may include a first subgroup of operations and a second subgroup of operations. The processor may execute the first subgroup of operations as a first concurrent plurality of threads that write disjointly to a set of memory locations of the shared dataset during a first set of time periods. The processor may execute the second subgroup of operations as a second concurrent plurality of threads that write disjointly to a subset of the set of memory locations during a second set of time periods. The first set of time periods and the second set of time periods may not overlap.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address efficient execution of iterative loops using multi-core processors. There is a need for improved iterative processing techniques.

### BRIEF SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to receive a representation of source code that includes a group of operations that write to a shared dataset. The group of operations may include a first subgroup of operations and a second subgroup of operations. The at least one processor may be configured to execute the first subgroup of operations as a first concurrent plurality of threads that write disjointly to a set of memory locations of the shared dataset during a first set of time periods. The at least one processor may be configured to execute the second subgroup of operations as a second concurrent plurality of threads that write disjointly to a subset of the set of memory locations during a second set of time periods. The first set of time periods and the second set of time periods may not overlap.

In some aspects, the techniques described herein relate to a method for graphics processing, including: receiving a representation of source code including a group of operations that write to a shared dataset, where the group of operations includes a first subgroup of operations and a second subgroup of operations; executing the first subgroup of operations as a first concurrent plurality of threads that write disjointly to a set of memory locations of the shared dataset during a first set of time periods; and executing the second subgroup of operations as a second concurrent plurality of threads that write disjointly to a subset of the set of memory locations during a second set of time periods, where the first set of time periods and the second set of time periods do not overlap.

In some aspects, the techniques described herein relate to a method, where the first subgroup of operations includes a plurality of iterations of a write command configured to write to the shared dataset, where each iteration of the plurality of iterations corresponds with one thread of the first concurrent plurality of threads, where each write command for each thread of the plurality of threads writes to a disjoint memory location of the shared dataset with respect to every other write command of the plurality of threads during the execution of the first subgroup of operations for each time period of the first set of time periods.

In some aspects, the techniques described herein relate to a method, where executing the first subgroup of operations as the first concurrent plurality of threads that write disjointly to the set of memory locations of the shared dataset during the first set of time periods includes: outputting a first indication of the first concurrent plurality of threads to a shader processor (SP) for parallel execution of the first concurrent plurality of threads during the first set of time periods, where executing the second subgroup of operations as the second concurrent plurality of threads that write disjointly to at least the subset of the set of memory locations during the second set of time periods includes: outputting a second indication of the second concurrent plurality of threads to the SP for parallel execution of the second concurrent plurality of threads during the second set of time periods.

In some aspects, the techniques described herein relate to a method, where a shader processor includes a plurality of SPs, where the plurality of SPs includes the SP.

In some aspects, the techniques described herein relate to a method, further including: assigning the first subgroup of operations and the second subgroup of operations to a common workgroup, where executing the first subgroup of operations as the first concurrent plurality of threads and executing the second subgroup of operations as the second concurrent plurality of threads includes: outputting an indication of the common workgroup to a shader processor (SP) for serial execution of each subgroup of operations of the common workgroup and parallel execution of each thread of each subgroup of operations of the common workgroup.

In some aspects, the techniques described herein relate to a method, where the group of operations includes an iterative loop having a write function to a shared array of elements, where the iterative loop iterates the write function through the shared array of elements.

In some aspects, the techniques described herein relate to a method, where the group of operations includes an atomic function that writes to the shared dataset.

In some aspects, the techniques described herein relate to a method, further including: replacing the atomic function with a non-atomic function before the execution of the first subgroup of operations and the execution of the second subgroup of operations, where, during the execution of the first concurrent plurality of threads, the non-atomic function writes disjointly to the set of memory locations of the shared dataset during the first set of time periods, where, during the execution of the second concurrent plurality of threads, the non-atomic function writes disjointly to at least the subset of the set of memory locations during the second set of time periods.

In an aspect of the disclosure, a method, a computer-readable medium, and an apparatus are provided. The apparatus may include a memory; and at least one processor coupled to the memory and, based at least in part on information stored in the memory, the at least one processor may be configured to receive a representation of source code including a group of operations that write to a shared dataset. The group of operations may include a first subgroup of operations and a second subgroup of operations. The at least one processor may be configured to execute all of the first subgroup of operations as a first concurrent set of threads that write to a disjoint set of memory locations of the shared dataset during a first set of time periods. The at least one processor may be configured to execute all of the second subgroup of operations as a second concurrent set of threads that write to a disjoint subset of the set of memory locations during a second set of time periods. The first set of time periods and the second set of time periods may not overlap.

In an aspect of the disclosure, a method, a computer-readable medium, and an apparatus are provided. The apparatus may include a memory; and at least one processor coupled to the memory and, based at least in part on information stored in the memory, the at least one processor may be configured to receive an indication of a group of iterations that write to a shared dataset. A corresponding write command for each iteration of the group of iterations may be offset from every other write command of the group of iterations. The at least one processor may be configured to split the group of iterations into a first subgroup of iterations and a second subgroup of iterations. The at least one processor may be configured to concurrently execute all of the first subgroup of iterations during a first set of time periods. The at least one processor may be configured to concurrently execute all of the second subgroup of iterations during a second set of time periods. The first set of time periods and the second set of time periods may not overlap.

In some aspects, the techniques described herein relate to a method of graphics processing, including: receiving an indication of a group of iterations that write to a shared dataset, where a corresponding write command for each iteration of the group of iterations is offset from every other write command of the group of iterations; splitting the group of iterations into a first subgroup of iterations and a second subgroup of iterations; and concurrently executing all of the first subgroup of iterations during a first set of time periods and concurrently executing all of the second subgroup of iterations during a second set of time periods, where the first set of time periods and the second set of time periods do not overlap.

In some aspects, the techniques described herein relate to a method, where concurrently executing all of the first subgroup of iterations during the first set of time periods and concurrently executing all of the second subgroup of iterations during the second set of time periods includes: outputting a first indication of the first subgroup of iterations to a shader processor (SP) for parallel execution of the first subgroup of iterations; and outputting a second indication of the second subgroup of iterations to the SP for parallel execution of the second subgroup of iterations.

In some aspects, the techniques described herein relate to a method, where a shader processor includes a plurality of SPs, where the plurality of SPs include the SP.

In some aspects, the techniques described herein relate to a method, further including: assigning the first subgroup of iterations and the second subgroup of iterations to a common workgroup; where concurrently executing all of the first subgroup of iterations during the first set of time periods and concurrently executing all of the second subgroup of iterations during the second set of time periods includes: outputting an indication of the common workgroup to a shader processor (SP) for parallel execution of each subgroup of iterations for the common workgroup.

In some aspects, the techniques described herein relate to a method, where receiving the indication of the group of iterations that write to the shared dataset includes: receiving a representation of source code including an iterative loop including a shared write function to an array of elements, where the iterative loop iterates the shared write function through the array of elements.

In some aspects, the techniques described herein relate to a method, where the shared write function includes an atomic write function.

In some aspects, the techniques described herein relate to a method, where the shared dataset includes a shared array of elements, where the group of iterations iterate through the shared array of elements.

In some aspects, the techniques described herein relate to a method, where concurrently executing all of the first subgroup of iterations during the first set of time periods and concurrently executing all of the second subgroup of iterations during the second set of time periods includes: associating each of the first subgroup of iterations with one thread of a first plurality of threads; associating each of the second subgroup of iterations with one thread of a second plurality of threads; concurrently executing each of the first plurality of threads during the first set of time periods; and concurrently executing each of the second plurality of threads during the second set of time periods.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example GPU with shared processing units, in accordance with one or more techniques of this disclosure.

FIG. 4 illustrates an example set of threads that write to a shared dataset, in accordance with one or more techniques of this disclosure.

FIG. 5A-5C illustrate an example set of threads that write to a shared dataset, in accordance with one or more techniques of this disclosure.

FIGS. 6A-6C illustrate examples of pseudocode that may be converted to replace atomic functions with non-atomic functions, in accordance with one or more techniques of this disclosure.

FIGS. 7A-7B illustrate examples of pseudocode that may be converted to replace atomic functions with non-atomic functions, in accordance with one or more techniques of this disclosure.

FIG. 8 illustrates a table of an example set of threads having looped iterations that write to a shared dataset, in accordance with one or more techniques of this disclosure.

FIG. 9 is a call flow diagram illustrating example communications between a CPU and a GPU in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor (or graphics processor system) may receive a representation of source code including a group of operations that write to a shared dataset. The group of operations may include a first subgroup of operations and a second subgroup of operations. A representation of source code may include raw source code, or an intermediate representation (IR) of the source code. In some aspects, a compiler of the graphics processor may be configured to detect that a set of operations in the source code may modify the same shared dataset, but, if executed concurrently in separate threads may write to disjoint memory locations within the same shared dataset. As such, the compiler may replace atomic operations that safely lock the shared dataset so that each operation does not simultaneously write to the same shared dataset with non-atomic operations that simultaneously write disjointly to a set of memory locations of the shared dataset with the help of scheduling. The graphics processor may execute the first subgroup of operations as a first concurrent plurality of threads that write disjointly to a set of memory locations of the shared dataset during a first set of time periods. Threads that write disjointly to a set of common memory locations shared between the threads are configured to simultaneously perform a write operation in such a manner that no two threads simultaneously write to the same memory address. The graphics processor may execute the second subgroup of operations as a second concurrent plurality of threads that write disjointly to a subset of the set of memory locations during a second set of time periods. The first set of time periods and the second set of time periods may not overlap. In other words, while each subgroup may concurrently execute each of the operations as a separate thread, where no two threads in the same subgroup write to the same memory address in the same time period, each concurrent plurality of threads may be scheduled to execute in different time periods (e.g., serially), ensuring that threads from one subgroup that may write to the same memory address of threads in another subgroup do not execute concurrently with one another and accidentally write to the same memory address during the same time period.

In some examples, a graphics processor (or graphics processor system) may receive an indication of a group of iterations that write to a shared dataset. An iteration that writes to a dataset may be an iterative loop, where each loop includes a write command to a dataset. A group of iterations that write to a shared dataset is a plurality of iterations, where each of the plurality of iterations includes a write command to the same dataset that each of the other iterations of the plurality of iterations write to. The iterative loop may be, for example, a for loop or a while loop that iterates through a sequential count, for example a for loop that loops an i value from 0 to 99. A corresponding write command for each iteration of the group of iterations may be offset from every other write command of the group of iterations. A group of iterations may share a common iteration, where each iteration includes the same set of instructions, but may not share the same iterative counter. Corresponding write commands that are offset may sequentially iterate through elements of a dataset in an offset manner, such that a first iteration iterates through a first set of sequential counts, and a second iteration iterates through a second set of sequential counts, where the first set of sequential counts and the second set of sequential counts are offset from one another. For example, the first set may be from 0 to N and the second set of sequential counts may be from 1 to N. The graphics processor may split the group of iterations into a first subgroup of iterations and a second subgroup of iterations. The graphics processor may concurrently execute all of the first subgroup of iterations during a first set of time periods and concurrently execute all of the second subgroup of iterations during a second set of time periods. The first set of time periods and the second set of time periods may not overlap. In other words, each subgroup may concurrently execute each of the iterations as a separate thread, but the threads of one subgroup of the group of iterations may not be executed at the same time as the threads of another subgroup of the group of iterations.

In one aspect, a representation of source code may use a large number of atomic operations. The representation of source code may have a group of iterations that each contain a common atomic write operation, where the common atomic write operations writes to a shared dataset. A graphics processor may split the group of iterations of the into subgroups, where each subgroup comprises a subset of the group of iterations. The group of iterations may also be referred to as a workgroup. The graphics processor may schedule all of the subgroups of the workgroup to a single processing unit, or shader processor (SP), of a shader processor. The SP may then concurrently execute all of the iterations in a subgroup in concurrently running threads but may not execute an iteration of one subgroup at the same time as the SP executes an iteration of another subgroup. In other words, all threads in each subgroup may be executed in a single instruction, multiple data (SIMD) fashion. As a result, no two threads would modify the same specific memory location for a given iteration of an iterative loop, even if, as a whole, the iterations write to the same shared dataset.

Particular aspects of the subject matter described in this disclosure can be implemented to realize one or more of the following potential advantages. In some examples, by concurrently executing subgroups of iterations in different time periods, the described techniques can be used to ensure that no two iterations write to the same specific memory location. Such a structure avoids the use of atomic functions, which can significantly increase the processing time of iterative loops.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

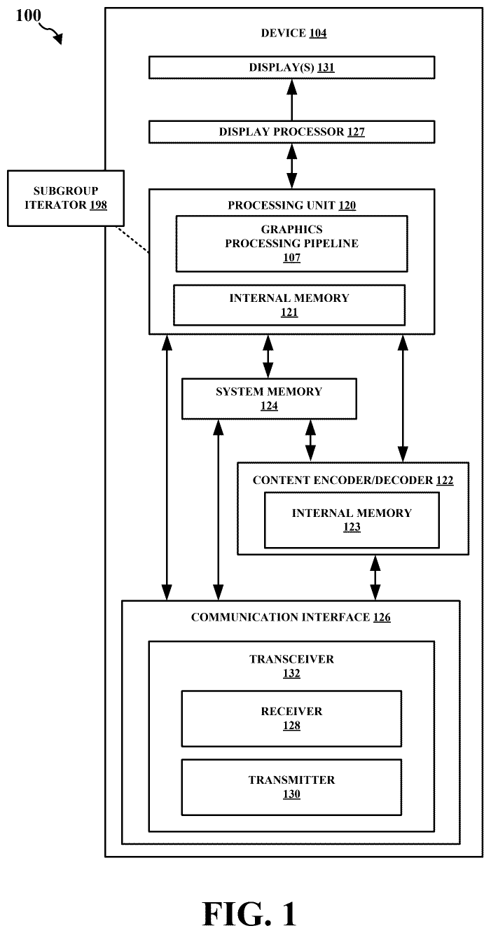

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104 or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a subgroup iterator 198 configured to receive a representation of source code. The source code may include a group of operations that write to a shared dataset. The group of operations may include a first subgroup of operations and a second subgroup of operations. The subgroup iterator 198 may be configured to execute the first subgroup of operations as a first concurrent plurality of threads that write disjointly to a set of memory locations of the shared dataset during a first set of time periods. The subgroup iterator 198 may be configured to execute the second subgroup of operations as a second concurrent plurality of threads that write disjointly to a subset of the set of memory locations during a second set of time periods. The first set of time periods and the second set of time periods may not overlap.

In certain aspects, the subgroup iterator 198 may be configured to receive an indication of a group of iterations that write to a shared dataset. A corresponding write command for each iteration of the group of iterations may be offset from every other write command of the group of iterations. The subgroup iterator 198 may be configured to split the group of iterations into a first subgroup of iterations and a second subgroup of iterations. The subgroup iterator 198 may be configured to concurrently execute all of the first subgroup of iterations during a first set of time periods and concurrently execute all of the second subgroup of iterations during a second set of time periods. The first set of time periods and the second set of time periods may not overlap. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

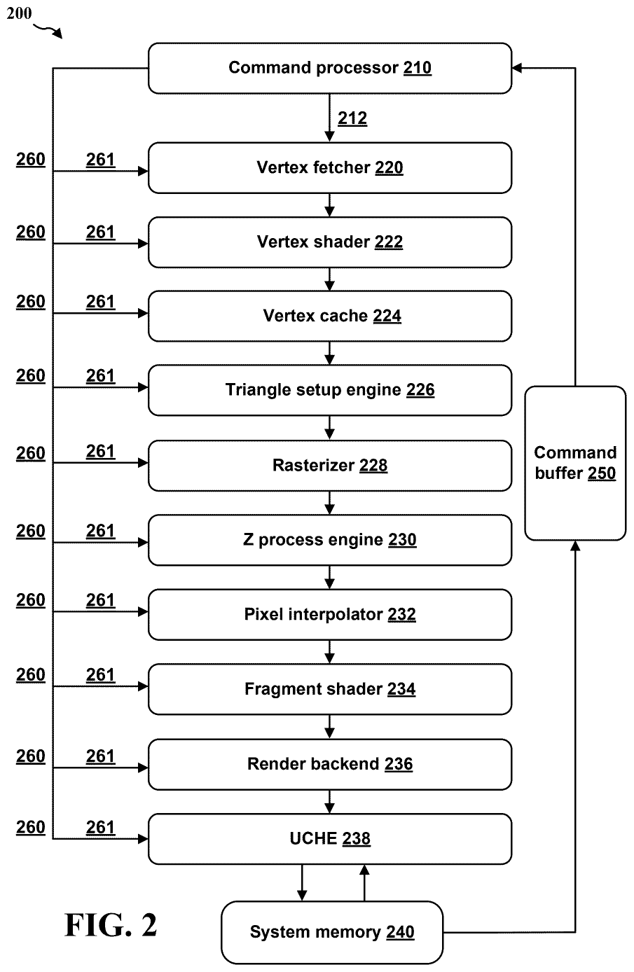

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

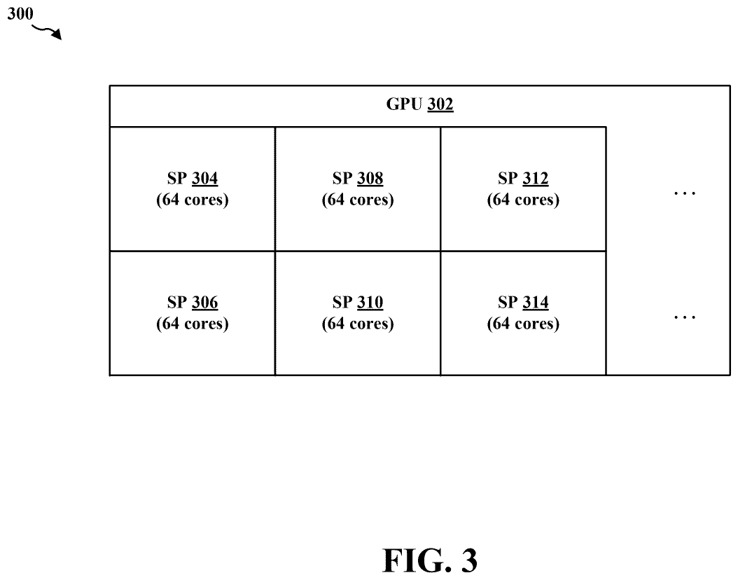

FIG. 3 is a diagram 300 illustrating an example GPU 302 configured to utilize a set of processing units, such as the shader processor (SP) 304, the SP 306, the SP 308, the SP 310, the SP 312, and the SP 314. GPU 302 may also be referred to as a multi-SP processor or a multi-core processor. While the GPU 302 shows six SPs, a multi-SP GPU may have any number of SPs that may be used to concurrently execute a set of threads. While each SP is shown to be configured to execute a maximum of 64 threads simultaneously, the number of simultaneous threads that each SP may execute may be different, for example 32 concurrent threads or 128 concurrent threads. Each SP may have the same number of cores and may be fungible with one another. In other words, each SP may concurrently execute the same maximum number of threads. Each thread may execute each common instruction of a common iteration using the same number of cycles. For example, a common iteration may have an add instruction followed by a store instruction. An SP configured to concurrently execute 64 threads of the common iteration may use the same number of cycles to complete each add instruction and the same number of cycles to complete each store instruction. The cores of each SP may be single instruction, multiple data (SIMD) processors configured to allow a single CPU instruction to simultaneously process multiple data points. The GPU 302 may schedule tasks, such as iterative write commands, to an SP, which may be capable of concurrently executing a set of threads simultaneously, for example, 64 threads.

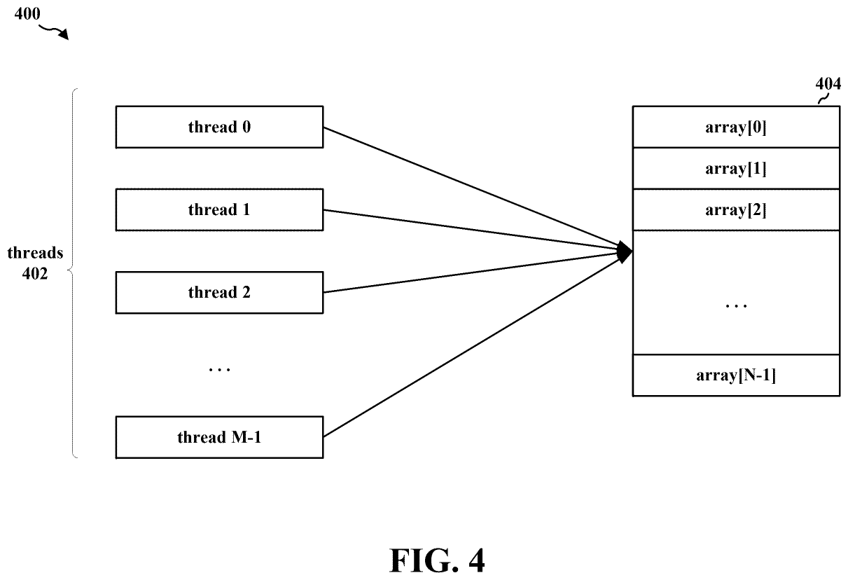

FIG. 4 is a diagram 400 of a set of threads 402 configured to write to a shared dataset 404. The set of threads 402 may include M threads, which may be enumerated from 0 to M−1. Each of the set of threads 402 may include an atomic write function, for example an atomic_min(array[i], x) function (a function to write the variable x to array[i] if x<array[i]) or an atomic_max(array[i], x) function (a function to write the variable x to array[i] if x>array[i]). The shared dataset 404 may be an array having N elements which may be enumerated from 0 to N−1. The variable array[0] may refer to the first element of the shared dataset 404 and the variable array[N−1] may refer to the last element of the shared dataset 404. To prevent the set of threads 402 from improperly writing to the shared dataset 404 simultaneously, a processing unit, such as an SP, may be configured to use atomic functions in the set of threads 402 to write to the shared dataset 404. For example, while thread 0 executes an atomic function that writes to the shared dataset 404, the atomic function may lock the shared dataset 404 to prevent any other thread of the set of threads 402 from writing to the shared dataset 404 until the atomic function finishes writing to the shared dataset 404. However, use of such atomic functions may severely impact processing performance, as the other threads may be waiting for other atomic functions to complete before proceeding with its write command. In some aspects, the threads may not be writing to the same specific area, or memory location, of the shared dataset 404, which means that use of the atomic function simply contributes to performance overhead.

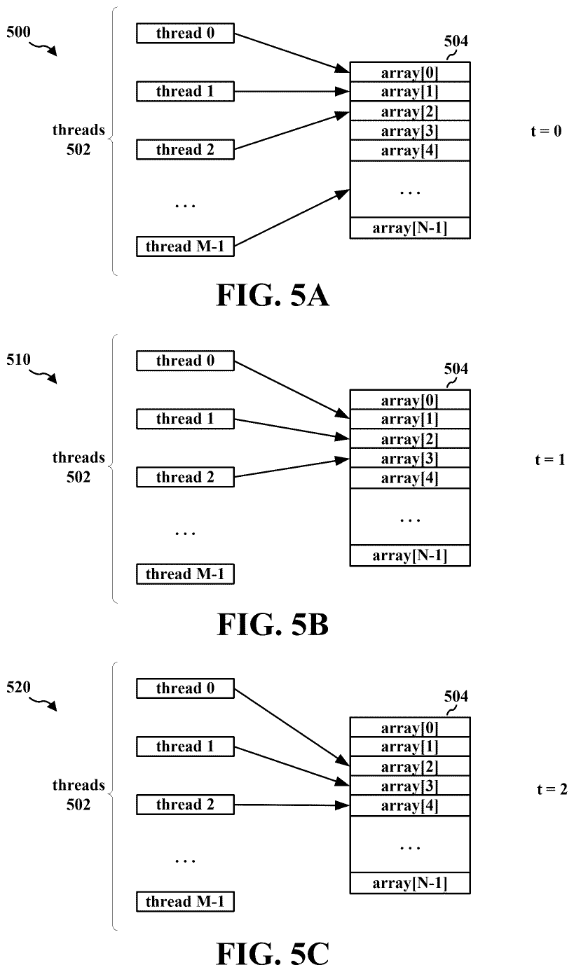

FIG. 5A is a diagram 500 of a set of threads 502 configured to write to a shared dataset 504 at a time t=0. The set of threads 502 may also be enumerated from 0 to M−1, and the shared dataset 504 may also have arrays that are enumerated from 0 to N−1. However, each of the threads may be configured to simultaneously write to a different specific memory location of the shared dataset 504. For example, thread 0 of the set of threads 502 may be configured to write to element 0 of the array (i.e., array[0]) of the shared dataset 504, thread 1 of the set of threads 502 may be configured to write to element 1 of the array (i.e., array[1]) of the shared dataset 504, and thread 2 of the set of threads 502 may be configured to write to element 2 of the array (i.e., array[2]) of the shared dataset 504 at time t=0.

FIG. 5B is a diagram 510 of the set of threads 502 and the shared dataset 504 of FIG. 5B at the time t=1. At time t=1, each of the threads of the set of threads 502 may also be configured to simultaneously write to a different specific memory location of the shared dataset 504, different from the time t=0. For example, thread 0 of the set of threads 502 may be configured to write to array[1] of the shared dataset 504, thread 1 of the set of threads 502 may be configured to write to array[2] of the shared dataset 504, and thread 2 of the set of threads 502 may be configured to write to array[3] of the shared dataset 504 at time t=1.

FIG. 5C is a diagram 520 of the set of threads 502 and the shared dataset 504 of FIG. 5B at the time t=2. At time t=2, each of the threads of the set of threads 502 may also be configured to simultaneously write to a different specific memory location of the shared dataset 504, different from the time t=0 and t=1. For example, thread 0 of the set of threads 502 may be configured to write to array[2] of the shared dataset 504, thread 1 of the set of threads 502 may be configured to write to array[3] of the shared dataset 504, and thread 2 of the set of threads 502 may be configured to write to array[4] of the shared dataset 504 at time t=2.

As shown, a single time period may be illustrative of how threads whose write locations are offset from one another can simultaneously write to different specific memory locations of a shared dataset, such as the shared dataset 504, and so long as each iteration increments/decrements at the same rate and controls which memory locations are being written to, a processor may ensure that the threads maintain their ability to avoid writing to the same memory location as they iterate through a loop.

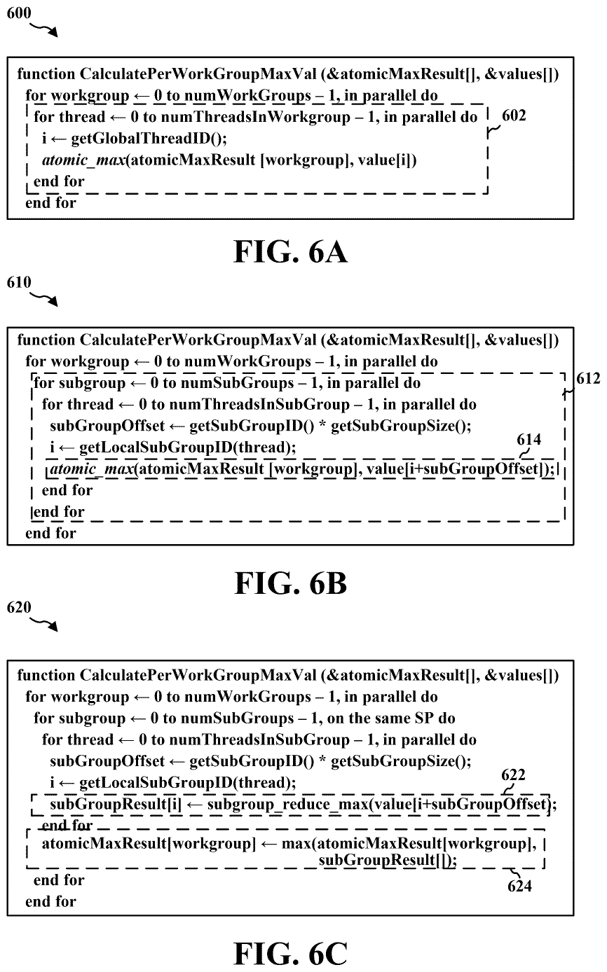

FIG. 6A is a diagram 600 of pseudocode for a search of a maximum value in a workgroup. The pseudocode may represent code that may be executed in parallel on the kernels of a set of multi-core processors. The pseudocode may include a group of operations, shown as a for loop that iterates through a number of workgroups represented by the variable numWorkGroups. A processor may execute each of the workgroups in parallel. For example, each iteration of the for loop from 0 to numWorkGroups−1 may be executed in parallel on different processors. Each workgroup may include a plurality of threads, where each thread may be executed in parallel by an SP. The number of threads executing in parallel may be limited by a number of cores of a processor (e.g., an SP), represented here as the variable numThreadsInWorkgroup. The threads of each workgroup are shown represented as a for loop of instructions 602, which iterate from 0 to numThreadsinWorkgroup−1. When executed by a set of processors, the instructions 602 may, for each thread in the workgroup, execute an atomic_max function that writes a result to the shared dataset atomicMaxResult[workgroup]. A max function may compare the variable atomicMaxResult[workgroup] against the variable value[i] and copy value[i] to atomicMaxResult[workgroup] if value[i] is greater than atomicMaxResult[workgroup]. The atomic_max function may ensure that no two threads write to the shared dataset atomicMaxResult[workgroup] during the same time period by locking the function such that two threads cannot execute the function during the same time period. In other words, the atomic_max function may prevent concurrently executing threads from interfering with one another, such as by concurrently writing to the same memory location. If the atomic_max function were instead a non-atomic max function, when the threads all execute in parallel, each of the threads may concurrently write to the same shared memory location shown in the pseudocode of atomicMaxResult[workgroup], causing a conflict.

In some aspects, a compiler may be configured to analyze the pseudocode in diagram 600, identify the workgroup, and may split the workgroup into an equivalent subgroup-based representation, as shown in FIG. 6B. The compiler may identify a workgroup via any suitable means, for example by identifying an iterative loop that iterates through the loop using a variable name with the string “workgroup,” or by identifying a set of operations that have a same common characteristic as a user-identified workgroup. For example, a user may label a plurality of sets of operations as a workgroup, the compiler may use machine learning to identify a common characteristic between the plurality of sets of operations and may identify a new set of operations as a workgroup for having the same identified common characteristic.

FIG. 6B is a diagram 610 of the pseudocode of FIG. 6A with the instructions 602 replaced by the instructions 612, which includes a for loop that iterates through a number of subgroups represented by the variable numSubGroups. A multi-core processor, such as the GPU 302 of FIG. 3, having a plurality of SPs may allocate each subgroup of a workgroup to a separate SP for execution. Each subgroup may include a plurality of threads, represented by the variable numThreadsInSubGroup. A compiler may define the variable numThreadsInSubGroup to be equal to the number of sub-cores of an SP. For example, with respect to the GPU 302 of FIG. 3, each subgroup may be assigned 64 threads to execute concurrently on the SP (with the exception of the last subgroup, which is assigned the remainder of the threads). In other words, the compiler may map the instructions 602 of the plurality of threads in each workgroup of the instructions 602 to an equivalent subgroup-based representation as a plurality of subgroups, each having a plurality of threads, of the instructions 612. A compiler may convert a workgroup into a plurality of subgroups by generating the subGroupOffset variable, calculated as the product of a subgroup identifier (ID) (obtained via the getSubGroupID function) and the size of each subgroup (obtained via the getSubGroupSize function). The size of each subgroup may be equal to the number of threads, or numThreadsInSubGroup, per subgroup. The compiler may replace the atomic_max function of the instructions 602 with the atomic_max function 614. The atomic_max function 614 may iterate through a subset of the value[ ] array based on the subGroupOffset variable. The subGroupOffset variable may be referred to as an offset of the subgroup, while the workgroup variable may be referred to as a global offset for each of the workgroups.

In some aspects, a compiler may be configured to analyze the pseudocode in diagram 610 to identify an atomic function, split a workgroup into a number of subgroups that can be concurrently executed on separate SPs, and may modify the atomic function to be performed once per subgroup, as opposed to once per thread, and may transform the per-thread atomic functions to per-subgroup atomic operations, as shown in FIG. 6C.

FIG. 6C is a diagram 620 of the pseudocode of FIG. 6B with the atomic_max function 614 replaced with the subgroup specific operation subgroup_reduce_max, which ensures that the threads within the subgroups don't modify the same memory, as the subgroup_reduce_max function writes to a local variable for the subgroup, not in the shared dataset. In other words, the subGroupResult is a local variable in each thread, and is not part of the shared dataset. As a result, memory access for each thread in a subgroup is disjoint. In other words, an SP assigned to concurrently execute all of the threads for the subgroup will avoid executing threads that interfere with one another by using the subgroup_reduce_max function to ensure that each thread writes to a local variable for the subgroup. However, the atomicMaxResult[ ] array is a shared dataset between the subgroups. To ensure that the threads from one subgroup do not interfere with threads from another subgroup, the processor may assign each subgroup of the same workgroup to the same SP. Since the subgroups are assigned to the same SP unit, there is no need to use atomic operations to synchronize cross-subgroup updates as scheduling all subgroups to the same SP guarantees that no two subgroups in the same workgroup update the same memory location during the same time period. In summary, the atomic_max function 614 is replaced by the subgroup_reduce_max function 622 to create a local variable in each thread that is not part of the shared dataset, and the max function 624 to calculate the max value of each of the subGroupResults calculated by the concurrently executing threads in a subgroup. A processor may ensure that two subgroups in the same workgroup do not write to the same element of the atomicMaxResult array using the max function 624 by assigning each subgroup of the same workgroup to the same SP. Each workgroup may be assigned to different SPs to improve parallelism between workgroups.

In summary, a compiler may analyze the code in diagram 600, determine that a workgroup can be divided into subgroups that can write disjointly to a set of memory locations of a shared dataset using a non-atomic function, and, if it determines that the atomic function can be converted into such a non-atomic function, replace the atomic function with a non-atomic function that, when executed in parallel within each subgroup, writes disjointly to a set of memory locations of a shared dataset using a non-atomic function. This minimizes execution stalls when an atomic function locks other threads from writing to the same shared dataset. The compiler may determine that a plurality of subgroups can write disjointly to a set of memory locations of a shared dataset using a non-atomic function in a plurality of ways. In some aspects, the compiler may replace an atomic function with an equivalent non-atomic function (e.g., an atomic_max function with a max function, or an atomic_min function with a min function), and concurrently execute a set of subgroups while tracking exact memory locations that are being written to in order to determine whether the non-atomic functions write disjointly to a set of memory locations. In other aspects, the compiler may prompt a user for an input to identify whether an atomic function can be replaced with a non-atomic function and still write disjointly to a set of memory locations.

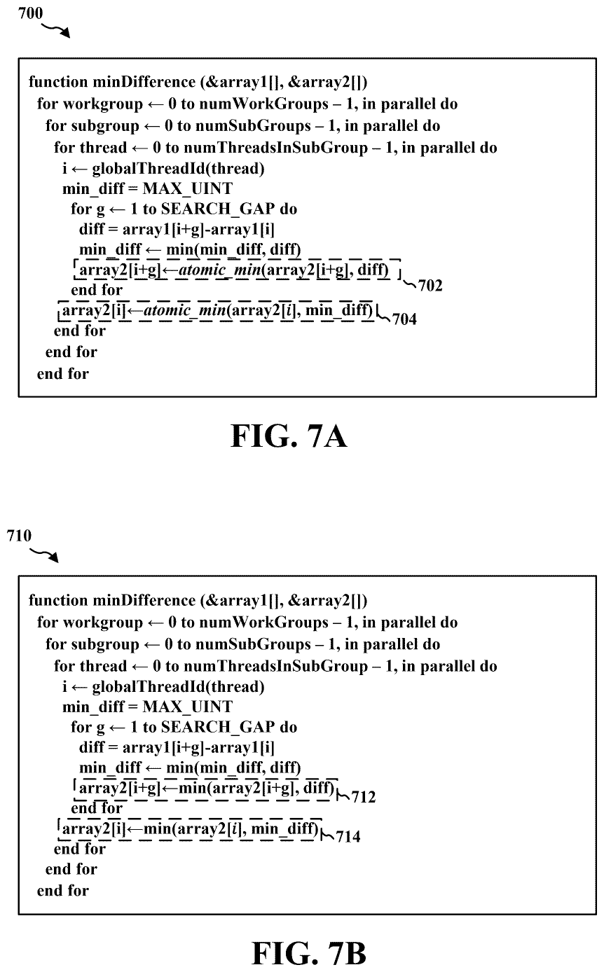

FIG. 7A is a diagram 700 of pseudocode for a minimum difference search used for determining a minimum difference between values in an array1[ ] within in a distance of SEARCH_GAP between an array value and a neighboring array value within the distance of SEARCH_GAP, where the minimum difference values are stored in an array[2]. As shown, the pseudocode in diagram 700 includes two atomic functions—the atomic function 702 and the atomic function 704—which may be used to prevent concurrently executing threads from interfering with one another (e.g., such as by concurrently writing to the same memory location). However, since the corresponding write command (e.g., atomic function 702, atomic function 704) for each thread of the subgroup writes disjointly to the same shared dataset as every other write command that concurrently runs in different threads of the same subgroup, then a processor may avoid executing threads that interfere with one another simply by assigning each subgroup of a workgroup to the same SP. A processor may analyze the pseudocode in diagram 700 and identify that each of the atomic function 702 and the atomic function 704 write disjointly to the same shared dataset as every other corresponding write command that concurrently runs in different threads of the same subgroup and may replace the atomic functions with non-atomic functions.

For example, FIG. 7B is a diagram 710 where the atomic function 702 is replaced with the non-atomic function 712, and the atomic function 704 is replaced with the non-atomic function 714. For each thread i from 0 to numThreadsInSubGroup, each thread may write disjointly to the same shared dataset of array2[ ] while each thread in the subgroup executes in parallel with one another.

Similar to the code in diagram 600, a compiler may analyze the code in diagram 700, determine that the atomic functions in a subgroup can be replaced with an equivalent non-atomic function and write disjointly to a set of memory locations of a shared dataset using the non-atomic function, and, if it determines that the atomic function can be converted into such a non-atomic function, replace the atomic function with a non-atomic function that, when executed in parallel within each subgroup, writes disjointly to a set of memory locations of a shared dataset using the non-atomic function. This minimizes execution stalls when an atomic function locks other threads from writing to the same shared dataset.

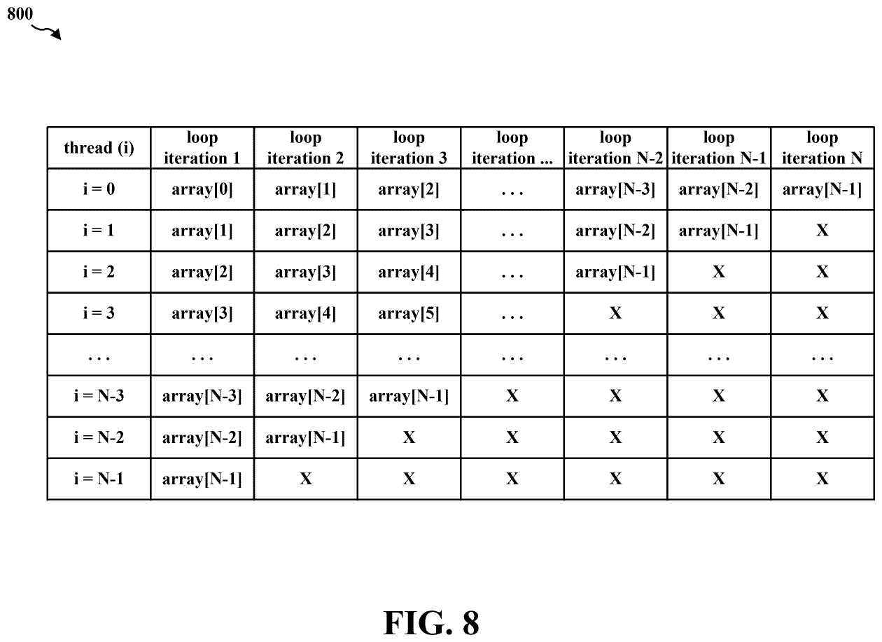

FIG. 8 is a diagram 800 illustrates a table of a set of threads enumerated from 0 to N−1 and a set of loops of each thread enumerated from 1 to N. A single SP may be configured to concurrently execute each of the threads, which ensures that each common iterative function is executed with the same delay. For example, a controller of a GPU may schedule all subgroups within a workgroup to be concurrently executed by a single processing unit of a shader processor, or micro-SP. By scheduling the subgroups in this manner, an SP may execute all threads within a given subgroup in SIMD fashion in a way such that the access pattern of array[i] is such that no two threads modify the same memory location for a given iteration of the common workgroup.

In loop iteration 1, each of the write commands may be offset from every other write command. For example, the write command for thread 0 may write to array[0] when the write command for thread 1 is writing to array[1] and so on and so forth. Similarly, during loop iteration 2, each of the write commands may again be offset from every other write command, even if each thread writes to a different memory location than the previous loop. For example, in loop iteration 2, the write command for thread 0 may write to array[1] when the write command for thread 1 is writing to array[2] and so on and so forth. As each thread iterates through its loop, each thread increments through each loop at the same rate, as the threads share common iterations, and the threads avoid writing to the same specific memory location, even as they simultaneously write to the same dataset.

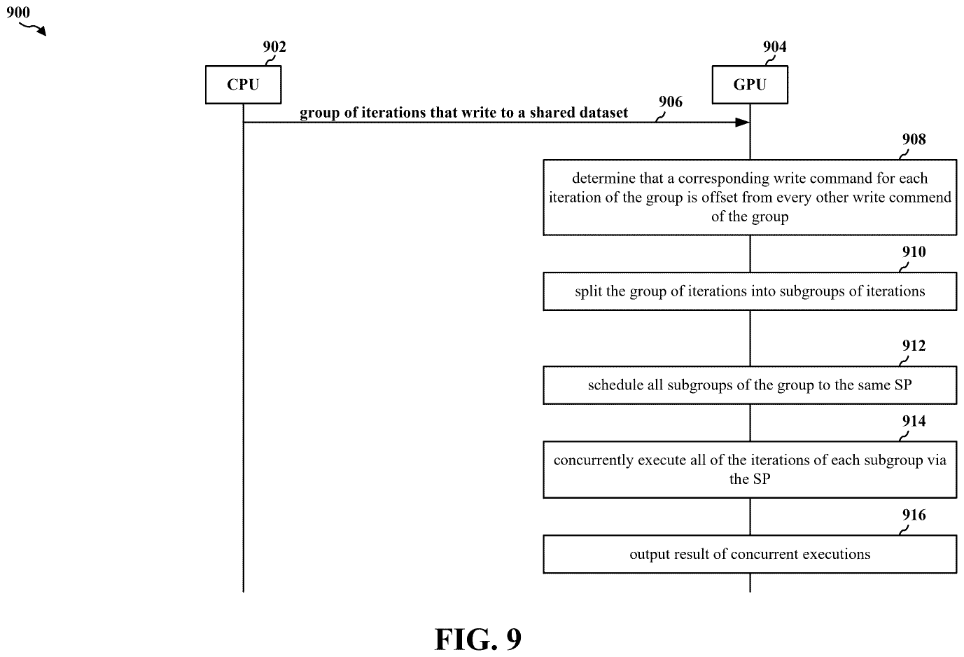

FIG. 9 is a call flow diagram 900 illustrating example communications between a CPU 902 and a GPU 904. The CPU 902 may output an indication 906 of a group of iterations that write to a shared dataset, for example an iterative loop of an atomic min function or an iterative loop of an atomic max function. The GPU 904 may receive the indication 906 of a group of iterations that write to a shared dataset. At 908, the GPU 904 may determine that a corresponding write command for each iteration of the group is offset from every other write command of the group. At 910, the GPU 904 may split the group of iterations into subgroups of iterations. At 912, the GPU 904 may schedule all subgroups of the group to the same SP. At 914, the GPU 904 may concurrently execute all of the iterations of each subgroup via the SP. At 916, the GPU 904 may output result of concurrent executions.

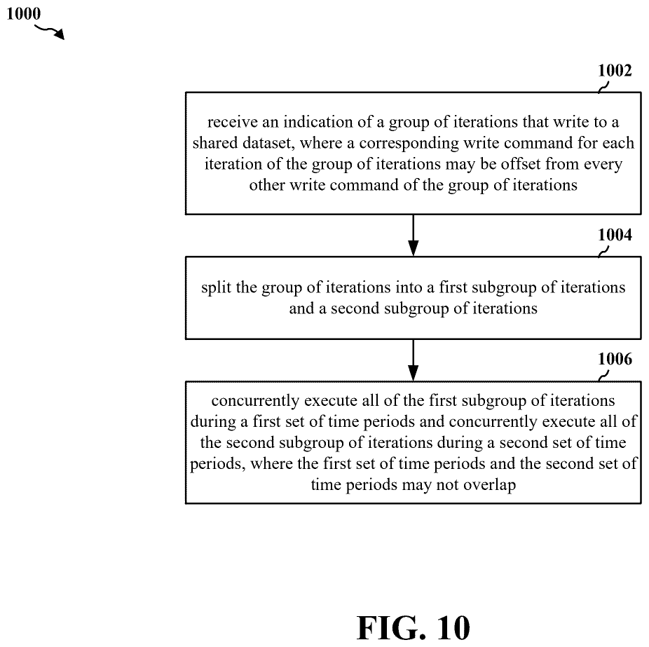

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, 5A-5C, 6A-6C, 7A-7B, and 8-9.

At 1002, the apparatus may receive an indication of a group of iterations that write to a shared dataset, where a corresponding write command for each iteration of the group of iterations may be offset from every other write command of the group of iterations For example, 1002 may be performed by the GPU 904 in FIG. 9, which may obtain an indication 906 of a representation of source code. The representation of source code may have a group of iterations (e.g., a for loop, a while loop) that write to a shared dataset (e.g., a common array that is provided to a write function for each loop). A corresponding write command for each iteration of the group of iterations may be offset from every other write command of the group of iterations. For example, a first thread may have an iteration that writes to an element array[0] during time t=3 when i=0 and a second thread may have an iteration that writes to an element array[1] during time t=3. The element array[0] is offset from array[1] at time t=3 such that both write commands do not simultaneously write to the same memory address. Moreover, 1002 may be performed by the subgroup iterator 198 in FIG. 1.

At 1004, the apparatus may split the group of iterations into a first subgroup of iterations and a second subgroup of iterations. For example, 1002 may be performed by the GPU 904 in FIG. 9, which may, at 910, split the group of iterations into a first subgroup of iterations and a second subgroup of iterations. Each subgroup may have a number of threads that equal the number of cores of an SP of the GPU 904. For example, if the GPU 904 has an SP with 64 cores, and the group of iterations has 128iterations, then the GPU 904 may split the group of iterations into a first subgroup having 64 threads, numbered from iterations 0 to 63, and a second subgroup having 64 threads numbered from iterations 64 to 127. Moreover, 1002 may be performed by the subgroup iterator 198 in FIG. 1.

At 1006, the apparatus may concurrently execute all of the first subgroup of iterations during a first set of time periods and concurrently execute all of the second subgroup of iterations during a second set of time periods, where the first set of time periods and the second set of time periods may not overlap. For example, 1002 may be performed by the GPU 904 in FIG. 9, which may, at 914, concurrently execute all of the first subgroup of iterations during a first set of time periods and concurrently execute all of the second subgroup of iterations during a second set of time periods. For example, the GPU 904 may assign the first subgroup of iterations and the second subgroup of iterations to the same SP. The SP may concurrently execute each iteration of the first subgroup of iterations as a separate thread of the SP during the first set of time periods and may concurrently execute each iteration of the second subgroup of iterations as a separate thread of the SP during the second set of time periods. The first set of time periods and the second set of time periods may not overlap. For example, the SP may concurrently execute the first set of threads before concurrently executing the second set of threads, or vice-versa. Moreover, 1002 may be performed by the subgroup iterator 198 in FIG. 1.

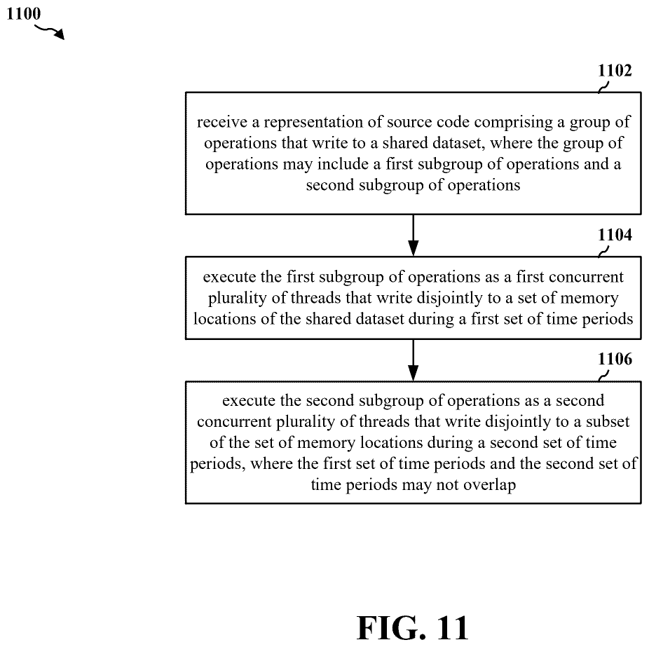

FIG. 11 is a flowchart 1100 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-4, 5A-5C, 6A-6C, 7A-7B, and 8-9.

At 1102, the apparatus may receive a representation of source code comprising a group of operations that write to a shared dataset. The group of operations may include a first subgroup of operations and a second subgroup of operations. For example, 1102 may be performed by the GPU 904 in FIG. 9, which may obtain the indication 906 from the CPU 902. The indication 906 may include a representation of source code. The representation of source code may include a group of operations that write to a shared dataset, for example iterations of a for loop or a while loop that write to a shared dataset, such as a common array. The group of operations may include a first subgroup of operations and a second subgroup of operations. In some aspects, at 910, the GPU 904 may split the group of operations into the first subgroup of operations and the second subgroup of operations. Moreover, 1102 may be performed by the subgroup iterator 198 in FIG. 1.

At 1104, the apparatus may execute the first subgroup of operations as a first concurrent plurality of threads that write disjointly to a set of memory locations of the shared dataset during a first set of time periods. For example, 1102 may be performed by the GPU 904 in FIG. 9, which may, at 914, execute the first subgroup of operations as a first concurrent plurality of threads that write disjointly to a set of memory locations of the shared dataset during a first set of time periods. The GPU 904 may concurrently execute each iteration of the first subgroup of operations in a separate thread of an SP, where each thread writes disjointly to different memory locations of the same common shared dataset. Moreover, 1102 may be performed by the subgroup iterator 198 in FIG. 1.

At 1106, the apparatus may execute the second subgroup of operations as a second concurrent plurality of threads that write disjointly to a subset of the set of memory locations during a second set of time periods. The first set of time periods and the second set of time periods may not overlap. For example, 1102 may be performed by the GPU 904 in FIG. 9, which may execute the second subgroup of operations as a second concurrent plurality of threads that write disjointly to a subset of the set of memory locations during a second set of time periods. The GPU 904 may concurrently execute each iteration of the second subgroup of operations in a separate thread of the same SP, where each thread writes disjointly to different memory locations of the same common shared dataset. The first set of time periods and the second set of time periods may not overlap. For example, the GPU 904 may execute the first concurrent plurality of threads and the second concurrent plurality of threads serially. Moreover, 1102 may be performed by the subgroup iterator 198 in FIG. 1.

In some aspects, the first subgroup of operations may include a plurality of iterations of a write command configured to write to the shared dataset. In some aspects, the group of operations may include a workgroup, and the apparatus may split the workgroup into a plurality of subgroups, where each subgroup of operations includes a plurality of iterations of a write command (e.g., an atomic operation) that is configured to write to the shared dataset. The apparatus may replace the atomic function with a non-atomic function that writes disjointly to the set of memory locations of the shared dataset when executed concurrently using a common SP. Each iteration of the plurality of iterations may correspond with one thread of the first concurrent plurality of threads. Each write command for each thread of the first concurrent plurality of threads may write to a disjoint memory location of the shared dataset with respect to every other write command of the first concurrent plurality of threads during the execution of the first subgroup of operations for each time period of the first set of time periods. For example, the threads may be similar to the threads in FIG. 8, which write disjointly to each element of the array within each time period of the loop iteration.

In some aspects, to execute the first subgroup of operations as the first concurrent plurality of threads that write disjointly to the set of memory locations of the shared dataset during the first set of time periods, the apparatus may output a first indication of the first concurrent plurality of threads to a SP for parallel execution of the first concurrent plurality of threads during the first set of time periods. In other words, each subgroup of the first subgroup of operations may be executed as a separate thread of the first concurrent plurality of threads of a same SP for parallel execution. To execute the second subgroup of operations as the second concurrent plurality of threads that write disjointly to at least the subset of the set of memory locations during the second set of time periods, the apparatus may output a second indication of the second concurrent plurality of threads to the same SP for parallel execution of the second concurrent plurality of threads during the second set of time periods. In other words, the same SP may execute each subgroup of a workgroup in serial, even as the SP executes every iteration of the subgroups in parallel.

A GPU may include a plurality of SPs, where one SP is assigned a plurality of subgroups for serial execution of each plurality of threads of the corresponding subgroup.

In some aspects, the apparatus may assign the first subgroup of operations and the second subgroup of operations to a common workgroup. In other words, a workgroup may have the first subgroup and the second subgroup. To execute the first subgroup of operations as the first concurrent plurality of threads and to execute the second subgroup of operations as the second concurrent plurality of threads, the apparatus may output an indication of the common workgroup to an SP for serial execution of each subgroup of operations of the common workgroup and parallel execution of each thread of each subgroup of operations of the common workgroup. In other words, the apparatus may assign a workgroup to an SP, where the SP handles serial executions of all of the subgroups in that workgroup.

In some aspects, the group of operations may include an iterative loop having a write function to a shared array of elements (e.g., a common array of elements). The iterative loop may iterate the write function through the shared array of elements (e.g., iterate through elements 0 to i of the common array).

In some aspects, the group of operations may include an atomic function that writes to the shared dataset. The apparatus may replace the atomic function with a non-atomic function before execution of each subgroup of operations in a manner such that each thread writes disjointly to the set of memory locations of the shared dataset.

In some aspects, the apparatus may determine that the group of operations includes the atomic function that writes to the shared dataset. The apparatus may replace the atomic function with a non-atomic function before the execution of the first subgroup of operations and the execution of the second subgroup of operations. During the execution of the first concurrent plurality of threads, the non-atomic function may write disjointly to the set of memory locations of the shared dataset during the first set of time periods. During the execution of the second concurrent plurality of threads, the non-atomic function may write disjointly to at least the subset of the set of memory locations during the second set of time periods.

In configurations, a method or an apparatus for graphics processing is provided. The apparatus may be a GPU, a CPU, or some other processor that may perform graphics processing. In aspects, the apparatus may be the processing unit 120 within the device 104 or may be some other hardware within the device 104 or another device. The apparatus may include means for receiving a representation of source code comprising a group of operations that write to a shared dataset. The group of operations may include a first subgroup of operations and a second subgroup of operations. The apparatus may further include means for executing the first subgroup of operations as a first concurrent plurality of threads that write disjointly to a set of memory locations of the shared dataset during a first set of time periods. The apparatus may further include means for executing the second subgroup of operations as a second concurrent plurality of threads that write disjointly to a subset of the set of memory locations during a second set of time periods. The first set of time periods and the second set of time periods may not overlap. The first subgroup of operations may include a plurality of iterations of a write command configured to write to the shared dataset. Each iteration of the plurality of iterations may correspond with one thread of the first concurrent plurality of threads. Each write command for each thread of the first concurrent plurality of threads may write to a disjoint memory location of the shared dataset with respect to every other write command of the first concurrent plurality of threads during the execution of the first subgroup of operations for each time period of the first set of time periods. The apparatus may further include means for executing the first subgroup of operations as the first concurrent plurality of threads that write disjointly to the set of memory locations of the shared dataset during the first set of time periods by outputting a first indication of the first concurrent plurality of threads to an SP for parallel execution of the first concurrent plurality of threads during the first set of time periods. The apparatus may further include means for executing the second subgroup of operations as the second concurrent plurality of threads that write disjointly to at least the subset of the set of memory locations during the second set of time periods by outputting a second indication of the second concurrent plurality of threads to the SP for parallel execution of the second concurrent plurality of threads during the second set of time periods. A GPU may include a plurality of SPs. The plurality of SPs may include the SP used for parallel execution of each of the first and second concurrent plurality of threads. The apparatus may further include means for assigning the first subgroup of operations and the second subgroup of operations to a common workgroup. The apparatus may further include means for executing the first subgroup of operations as the first concurrent plurality of threads and executing the second subgroup of operations as the second concurrent plurality of threads by outputting an indication of the common workgroup to an SP for serial execution of each subgroup of operations of the common workgroup and parallel execution of each thread of each subgroup of operations of the common workgroup. The group of operations may include an iterative loop having a write function to a shared array of elements. The iterative loop may iterate the write function through the shared array of elements. The group of operations may include an atomic function that writes to the shared dataset. The apparatus may further include means for replacing the atomic function with a non-atomic function before the execution of the first subgroup of operations and the execution of the second subgroup of operations. The apparatus may further include means for, during the execution of the first concurrent plurality of threads, enabling the non-atomic function to write disjointly to the set of memory locations of the shared dataset during the first set of time periods. The apparatus may further include means for, during the execution of the second concurrent plurality of threads, enabling the non-atomic function to write disjointly to at least the subset of the set of memory locations during the second set of time periods. The means may include the subgroup iterator 198 of FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: receiving an indication of a group of iterations that write to a shared dataset, wherein a corresponding write command for each iteration of the group of iterations is offset from every other write command of the group of iterations; splitting the group of iterations into a first subgroup of iterations and a second subgroup of iterations; and concurrently executing all of the first subgroup of iterations during a first set of time periods and concurrently executing all of the second subgroup of iterations during a second set of time periods, wherein the first set of time periods and the second set of time periods do not overlap.

Aspect 2 is the method of aspect 1, wherein concurrently executing all of the first subgroup of iterations during the first set of time periods and concurrently executing all of the second subgroup of iterations during the second set of time periods comprises: outputting a first indication of the first subgroup of iterations to a shared processor (SP) for parallel execution of the first subgroup of iterations; and outputting a second indication of the second subgroup of iterations to the SP for parallel execution of the second subgroup of iterations.

Aspect 3 is the method of aspect 2, wherein a graphics processing unit (GPU) comprises a plurality of SPs, wherein the plurality of SPs comprise the SP.

Aspect 4 is the method of any of aspects 1 to 3, further comprising: assigning the first subgroup of iterations and the second subgroup of iterations to a common workgroup; wherein concurrently executing all of the first subgroup of iterations during the first set of time periods and concurrently executing all of the second subgroup of iterations during the second set of time periods comprises: outputting an indication of the common workgroup to a shader processor (SP) for parallel execution of each subgroup of iterations for the common workgroup.

Aspect 5 is the method of any of aspects 1 to 4, wherein receiving the indication of the group of iterations that write to the shared dataset comprises: receiving a representation of source code comprising an iterative loop comprising a shared write function to an array of elements, wherein the iterative loop iterates the shared write function through the array of elements.

Aspect 6 is the method of aspect 5, wherein the shared write function comprises an atomic write function.

Aspect 7 is the method of any of aspects 1 to 6, wherein the shared dataset comprises a shared array of elements, wherein the group of iterations iterate through the shared array of elements.

Aspect 8 is the method of any of aspects 1 to 7, wherein concurrently executing all of the first subgroup of iterations during the first set of time periods and concurrently executing all of the second subgroup of iterations during the second set of time periods comprises: associating each of the first subgroup of iterations with one thread of a first plurality of threads; associating each of the second subgroup of iterations with one thread of a second plurality of threads; concurrently executing each of the first plurality of threads during the first set of time periods; and concurrently executing each of the second plurality of threads during the second set of time periods.

Aspect 9 is a method for graphics processing, comprising: receiving a representation of source code comprising a group of operations that write to a shared dataset, wherein the group of operations comprises a first subgroup of operations and a second subgroup of operations; executing the first subgroup of operations as a first concurrent plurality of threads that write disjointly to a set of memory locations of the shared dataset during a first set of time periods; and executing the second subgroup of operations as a second concurrent plurality of threads that write disjointly to a subset of the set of memory locations during a second set of time periods, wherein the first set of time periods and the second set of time periods do not overlap.

Aspect 10 is the method of aspect 9, wherein the first subgroup of operations comprises a plurality of iterations of a write command configured to write to the shared dataset, wherein each iteration of the plurality of iterations corresponds with one thread of the first concurrent plurality of threads, wherein each write command for each thread of the first concurrent plurality of threads writes to a disjoint memory location of the shared dataset with respect to every other write command of the first concurrent plurality of threads during the execution of the first subgroup of operations for each time period of the first set of time periods.

Aspect 11 is the method of either of aspects 9 or 10, wherein executing the first subgroup of operations as the first concurrent plurality of threads that write disjointly to the set of memory locations of the shared dataset during the first set of time periods comprises: outputting a first indication of the first concurrent plurality of threads to a shader processor (SP) for parallel execution of the first concurrent plurality of threads during the first set of time periods, wherein executing the second subgroup of operations as the second concurrent plurality of threads that write disjointly to at least the subset of the set of memory locations during the second set of time periods comprises: outputting a second indication of the second concurrent plurality of threads to the SP for parallel execution of the second concurrent plurality of threads during the second set of time periods.

Aspect 12 is the method of aspect 11, wherein a graphics processing unit (GPU) comprises a plurality of SPs, wherein the plurality of SPs comprises the SP.

Aspect 13 is the method of any of aspects 9 to 12, further comprising: assigning the first subgroup of operations and the second subgroup of operations to a common workgroup, wherein executing the first subgroup of operations as the first concurrent plurality of threads and executing the second subgroup of operations as the second concurrent plurality of threads comprises: outputting an indication of the common workgroup to a shader processor (SP) for serial execution of each subgroup of operations of the common workgroup and parallel execution of each thread of each subgroup of operations of the common workgroup.

Aspect 14 is the method of aspect 13, wherein the group of operations comprises an iterative loop having a write function to a shared array of elements, wherein the iterative loop iterates the write function through the shared array of elements.

Aspect 15 is the method of either aspect 13 or 14, wherein the group of operations comprises an atomic function that writes to the shared dataset.

Aspect 16 is the method of aspect 15, further comprising: replacing the atomic function with a non-atomic function before the execution of the first subgroup of operations and the execution of the second subgroup of operations, wherein, during the execution of the first concurrent plurality of threads, the non-atomic function writes disjointly to the set of memory locations of the shared dataset during the first set of time periods, wherein, during the execution of the second concurrent plurality of threads, the non-atomic function writes disjointly to at least the subset of the set of memory locations during the second set of time periods.

Aspect 17 is an apparatus for graphics processing including at least one processor coupled to a memory and configured to implement a method as in any of aspects 1-16.

Aspect 18 may be combined with aspect 17 and includes that the apparatus is a wireless communication device.

Aspect 19 is an apparatus for graphics processing including means for implementing a method as in any of aspects 1-17.

Aspect 20 is a computer-readable medium (e.g., a non-transitory computer-readable medium) storing computer executable code, the code when executed by at least one processor causes the at least one processor to implement a method as in any of aspects 1-17.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
receive a representation of source code comprising a group of operations that write to a shared dataset, wherein the group of operations comprises a first subgroup of operations and a second subgroup of operations;
execute the first subgroup of operations as a first concurrent plurality of threads that write disjointly to a set of memory locations of the shared dataset during a first set of time periods; and
execute the second subgroup of operations as a second concurrent plurality of threads that write disjointly to a subset of the set of memory locations during a second set of time periods, wherein the first set of time periods and the second set of time periods do not overlap.

2. The apparatus of claim 1, wherein the first subgroup of operations comprises a plurality of iterations of a write command configured to write to the shared dataset, wherein each iteration of the plurality of iterations corresponds with one thread of the first concurrent plurality of threads, wherein each write command for each thread of the first concurrent plurality of threads writes to a disjoint memory location of the shared dataset with respect to every other write command of the first concurrent plurality of threads during the execution of the first subgroup of operations for each time period of the first set of time periods.

3. The apparatus of claim 1, wherein, to execute the first subgroup of operations as the first concurrent plurality of threads that write disjointly to the set of memory locations of the shared dataset during the first set of time periods, the processor is configured to:
output a first indication of the first concurrent plurality of threads to a shader processor (SP) for parallel execution of the first concurrent plurality of threads during the first set of time periods, wherein, to execute the second subgroup of operations as the second concurrent plurality of threads that write disjointly to at least the subset of the set of memory locations during the second set of time periods, the processor is configured to:
output a second indication of the second concurrent plurality of threads to the SP for parallel execution of the second concurrent plurality of threads during the second set of time periods.

4. The apparatus of claim 3, wherein a graphics processing unit (GPU) comprises a plurality of SPs, wherein the plurality of SPs comprises the SP.

5. The apparatus of claim 1, wherein the processor is further configured to:
assign the first subgroup of operations and the second subgroup of operations to a common workgroup, wherein, to execute the first subgroup of operations as the first concurrent plurality of threads and to execute the second subgroup of operations as the second concurrent plurality of threads, the processor is configured to:
output an indication of the common workgroup to a shader processor (SP) for serial execution of each subgroup of operations of the common workgroup and parallel execution of each thread of each subgroup of operations of the common workgroup.

6. The apparatus of claim 1, wherein the group of operations comprises an iterative loop having a write function to a shared array of elements, wherein the iterative loop iterates the write function through the shared array of elements.

7. The apparatus of claim 1, wherein the group of operations comprises an atomic function that writes to the shared dataset.

8. The apparatus of claim 7, wherein the processor is further configured to:
determine that the group of operations comprises the atomic function that writes to the shared dataset; and
replace the atomic function with a non-atomic function before the execution of the first subgroup of operations and the execution of the second subgroup of operations, wherein, during the execution of the first concurrent plurality of threads, the non-atomic function writes disjointly to the set of memory locations of the shared dataset during the first set of time periods, wherein, during the execution of the second concurrent plurality of threads, the non-atomic function writes disjointly to at least the subset of the set of memory locations during the second set of time periods.

9. A method for graphics processing, comprising:
receiving a representation of source code comprising a group of operations that write to a shared dataset, wherein the group of operations comprises a first subgroup of operations and a second subgroup of operations;
executing the first subgroup of operations as a first concurrent plurality of threads that write disjointly to a set of memory locations of the shared dataset during a first set of time periods; and
executing the second subgroup of operations as a second concurrent plurality of threads that write disjointly to a subset of the set of memory locations during a second set of time periods, wherein the first set of time periods and the second set of time periods do not overlap.

10. The method of claim 9, wherein the first subgroup of operations comprises a plurality of iterations of a write command configured to write to the shared dataset, wherein each iteration of the plurality of iterations corresponds with one thread of the first concurrent plurality of threads, wherein each write command for each thread of the first concurrent plurality of threads writes to a disjoint memory location of the shared dataset with respect to every other write command of the first concurrent plurality of threads during the execution of the first subgroup of operations for each time period of the first set of time periods.

11. The method of claim 9, wherein executing the first subgroup of operations as the first concurrent plurality of threads that write disjointly to the set of memory locations of the shared dataset during the first set of time periods comprises:
outputting a first indication of the first concurrent plurality of threads to a shader processor (SP) for parallel execution of the first concurrent plurality of threads during the first set of time periods, wherein executing the second subgroup of operations as the second concurrent plurality of threads that write disjointly to at least the subset of the set of memory locations during the second set of time periods comprises:
outputting a second indication of the second concurrent plurality of threads to the SP for parallel execution of the second concurrent plurality of threads during the second set of time periods.

12. The method of claim 11, wherein a graphics processing unit (GPU) comprises a plurality of SPs, wherein the plurality of SPs comprises the SP.

13. The method of claim 9, further comprising:
assigning the first subgroup of operations and the second subgroup of operations to a common workgroup, wherein executing the first subgroup of operations as the first concurrent plurality of threads and executing the second subgroup of operations as the second concurrent plurality of threads comprises:
outputting an indication of the common workgroup to a shader processor (SP) for serial execution of each subgroup of operations of the common workgroup and parallel execution of each thread of each subgroup of operations of the common workgroup.

14. The method of claim 9, wherein the group of operations comprises an atomic function that writes to the shared dataset.

15. The method of claim 14, further comprising:
replacing the atomic function with a non-atomic function before the execution of the first subgroup of operations and the execution of the second subgroup of operations, wherein, during the execution of the first concurrent plurality of threads, the non-atomic function writes disjointly to the set of memory locations of the shared dataset during the first set of time periods, wherein, during the execution of the second concurrent plurality of threads, the non-atomic function writes disjointly to at least the subset of the set of memory locations during the second set of time periods.

16. A computer-readable medium storing computer executable code, the code, when executed by a processor, causes the processor to:
receive a representation of source code comprising a group of operations that write to a shared dataset, wherein the group of operations comprises a first subgroup of operations and a second subgroup of operations;
execute the first subgroup of operations as a first concurrent plurality of threads that write disjointly to a set of memory locations of the shared dataset during a first set of time periods; and
execute the second subgroup of operations as a second concurrent plurality of threads that write disjointly to a subset of the set of memory locations during a second set of time periods, wherein the first set of time periods and the second set of time periods do not overlap.

17. The computer-readable medium of claim 16, wherein the code, when executed by the processor, causes the processor to:
assign the first subgroup of operations and the second subgroup of operations to a common workgroup, wherein, to execute the first subgroup of operations as the first concurrent plurality of threads and to execute the second subgroup of operations as the second concurrent plurality of threads, the code, when executed by the processor, causes the processor to:
output an indication of the common workgroup to a shader processor (SP) for serial execution of each subgroup of operations of the common workgroup and parallel execution of each thread of each subgroup of operations of the common workgroup.

18. The computer-readable medium of claim 16, wherein the group of operations comprises an atomic function that writes to the shared dataset, wherein the code, when executed by the processor, causes the processor to:
determine that the group of operations comprises the atomic function that writes to the shared dataset; and
replace the atomic function with a non-atomic function before the execution of the first subgroup of operations and the execution of the second subgroup of operations, wherein, during the execution of the first concurrent plurality of threads, the non-atomic function writes disjointly to the set of memory locations of the shared dataset during the first set of time periods, wherein, during the execution of the second concurrent plurality of threads, the non-atomic function writes disjointly to at least the subset of the set of memory locations during the second set of time periods.

19. The computer-readable medium of claim 16, wherein, to execute the first subgroup of operations as the first concurrent plurality of threads that write disjointly to the set of memory locations of the shared dataset during the first set of time periods, the code, when executed by the processor, causes the processor to:
output a first indication of the first concurrent plurality of threads to a shader processor (SP) for parallel execution of the first concurrent plurality of threads during the first set of time periods, wherein, to execute the second subgroup of operations as the second concurrent plurality of threads that write disjointly to at least the subset of the set of memory locations during the second set of time periods, the code, when executed by the processor, causes the processor to:
output a second indication of the second concurrent plurality of threads to the SP for parallel execution of the second concurrent plurality of threads during the second set of time periods.

20. The computer-readable medium of claim 16, wherein the first subgroup of operations comprises a plurality of iterations of a write command configured to write to the shared dataset, wherein each iteration of the plurality of iterations corresponds with one thread of the first concurrent plurality of threads, wherein each write command for each thread of the first concurrent plurality of threads writes to a disjoint memory location of the shared dataset with respect to every other write command of the first concurrent plurality of threads during the execution of the first subgroup of operations for each time period of the first set of time periods.
